(19) United States
(12) Patent Application Publication
(10) Pub. No.: US 2020/0158199 A1
(43) Pub. Date: May 21, 2020

(54) WET FRICTION MATERIALS WITH MICA SILICATE

(71) Applicant: Schaeffler Technologies AG & Co. KG, Herzogenaurach (DE)

(72) Inventors: Murat Bakan, Wooster, OH (US); Rashid Farahati, Copley, OH (US)

(73) Assignee: Schaeffler Technologies AG & Co. KG, Herzogenaurach (DE)

(21) Appl. No.: 16/193,006

(22) Filed: Nov. 16, 2018

(51) Int. Cl. F16D 69/02

(52) U.S. Cl. CPC F16D 69/026; F16D 13/72

(57) ABSTRACT

Wet friction materials are disclosed. One wet friction material may include a plurality of fibers and a filler material including mica silicate. The mica silicate may comprise from 5 to 20 percent by weight of a total composition of the fibers and the filler material. In another example, the mica silicate may comprise from 7.5 to 17.5 percent by weight of a total composition of the fibers and the filler material. The filler material may include an additional silica-containing material.

### TECHNICAL FIELD

The present disclosure relates generally to wet friction materials, for example, including mica silicate.

### BACKGROUND

Friction materials for clutches may generally include fiber material and filler material. Typically, the fiber material forms the structure of the friction material and the filler material creates friction. Some friction materials may use diatomaceous earth for the filler material, for example.

### SUMMARY

In at least one embodiment, a wet friction material is provided. The wet friction material may include a plurality of fibers and a filler material including mica silicate. The mica silicate may comprise from 5 to 20 percent by weight of a total composition of the fibers and the filler material.

In another embodiment, the mica silicate comprises from 7.5 to 17.5 percent by weight of the total composition of the fibers and the filler material. The filler material may include an additional silica-containing material, such as diatomaceous earth. The mica silicate may be in the form of particles, which may have a particle size of 25 to 100 μm or 40 to 80 μm. The mica silicate may be in the form of particles having an aspect ratio of 50 to 70. In one embodiment, the wet friction material has a temperature resistance of at least 500° C.

### BRIEF DESCRIPTION OF THE DRAWINGS

FIG. 1 is a schematic cross-sectional view of friction material; and

FIG. 2 is a partial cross-sectional view of an example torque converter including the friction material shown in FIG. 1.

### DETAILED DESCRIPTION

At the outset, it should be appreciated that like drawing numbers appearing in different drawing views identify identical, or functionally similar, structural elements. Furthermore, it is understood that this disclosure is not limited only to the particular embodiments, methodology, materials and modifications described herein, and as such may, of course, vary. As those of ordinary skill in the art will understand, various features illustrated and described with reference to any one of the figures can be combined with features illustrated in one or more other figures to produce embodiments that are not explicitly illustrated or described.

The terminology used herein is for the purpose of describing particular aspects only, and is not intended to limit the scope of the present disclosure, which is limited only by the appended claims. It is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments.

Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

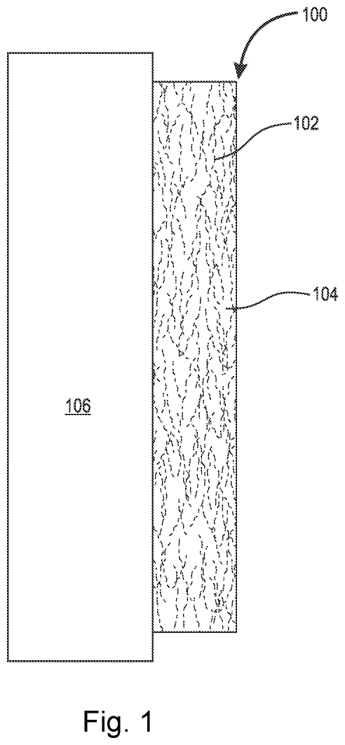

With reference to FIG. 1, a schematic cross-sectional view of friction material 100 is shown. Friction material 100 can be used on any clutch plate 106 known in the art. In the example embodiment shown, friction material 100 is fixedly secured to plate 106. Friction material 100 may include one or more fiber materials 102 and filler material 104. Friction material 100 may further include one or more binders, such as phenolic resin or latex. Fiber material 102 can be any organic or inorganic fiber known in the art, such as cellulose fibers, aramid fibers, or carbon fibers, or combinations thereof.

The filler material 104 may include a silica-containing material, such as diatomaceous earth, aluminum silicate, Celite®, Celatom®, or silicon dioxide. In at least one embodiment, the filler material 104 may include mica silicate. The mica silicate may be included in addition to one or more other silica-containing materials, such as those listed previously. Without being held to any particular theory, it is believed that the inclusion of mica silicate may increase the temperature resistance of the friction material 100.

The composition of mica silicates may generally be described as X₂Y₄₋₆Z₈O₂₀(OH, F)₄, wherein X is K, Na, Ca, Ba, Rb, or Cs; Y is Al, Mg, Fe, Mn, Cr, Ti, or Li; and Z is Si, Al, Fe³⁺, or Ti. However, any mica silicate may be used according to the disclosure. The mica silicate used in the filler material 104 may be in the form of a powder or particulates. The particles may generally have a flat or flake shape having a high aspect ratio (e.g., a high ratio of length/width to thickness). In one embodiment, the aspect ratio may be from 40 to 80, for example, 50 to 70 or about 60 (e.g., ±5). The aspect ratio may be determined according to the Jennings approach. In one embodiment, the particles may have a median particle size of 10 to 100 μm, or any sub-range therein. For example, the median particle size may be from 25 to 100 μm, 10 to 75 μm, 25 to 75 μm, 40 to 80 μm, or about 60 μm (e.g., ±10 μm).

It has been discovered that the inclusion of the mica silicate into the filler material 104 may improve the thermal/temperature resistance of the friction material 100. For example, a typical friction material may fail at a surface temperature of about 400° C. when tested using the method described in SAEJ2488. The test method will be described briefly herein, however, the full method is described in SAE International J2488, Revised August 2006, which is hereby incorporated by reference in its entirety. In general, the test method includes increasing steps of power, each level consisting of 200 engagements and one breakaway. Inspections are made of the reaction plates and friction assemblies at the end of each level. The different power levels are achieved by increasing the effective inertia while the stop time and initial engagement speed are kept constant at 0.6 s and 6000 r/min, respectively. The test is run at increasing power steps until the friction system has completely failed. The test method includes 14 test levels, referred to as B1 to B14, which represent increased piston application pressure.

In at least one embodiment, the inclusion of the mica silicate in the filler material 104 increased the temperature resistance of the friction material such that it reached about 600° C. before failure. This represents a substantial improvement over traditional friction materials, and is on-par with high-end or high-performance friction materials. Indeed, the friction material including the mica silicate exceed the level 14 test level in the test method, and additional extrapolated test levels were used to complete the testing. Accordingly, the friction material 100 may have a temperature resistance of at least 500° C., at least 550° C., at least 575° C., or at least 600° C. (e.g., when tested using SAEJ2488).

In at least one embodiment, the mica silicate may be included in the friction material 100 in an amount from 1 to 25 percent by weight, or any sub-range therein. In one embodiment, the mica silicate may be present in an amount from 5 to 20 percent by weight. In another embodiment, the mica silicate may be present in an amount from 7.5 to 17.5 percent by weight. In another embodiment, the mica silicate may be present in an amount from 10 to 15 percent by weight. Compositions outside of these ranges are also contemplated, however, the temperature resistance may be reduced or there may be diminishing returns. The above percentages may correspond to the total weight of the fiber material 102 and the filler material 104, but may exclude the binder (typically added in a later saturation process).

As described above, the mica silicate may form only a portion of the filler material 104. The balance of the filler material 104 may include other silica-containing materials, such as diatomaceous earth, aluminum silicate, Celite®, Celatom®, silicon dioxide, or a combination thereof. In one embodiment, the mica silicate may comprise from 15 to 50 percent by weight of the filler material, or any sub-range therein, such as 20 to 40 percent or 25 to 35 percent. Accordingly, the other silica-containing materials, such as diatomaceous earth, may comprise from 50 to 85 percent by weight, or any sub-range therein, such as 60 to 80 percent or 65 to 75 percent.

In one experiment, a friction material was produced with 10 wt. % mica silicate and was tested according to the SAEJ2488 test method. The friction material included about 55 percent by weight of fiber material (cellulose and aramid fibers) and about 35 percent by weight of diatomaceous earth and carbon-based filler material, and about 10 percent by weight of mica silicate (binders are excluded from the composition, but may comprise about 35 wt. % of the final material). The mica silicate used was IMERYS Suzorite 200-S. As referenced above, the sample did not fail even at the highest level (B14) of the test. The test method parameters were extrapolated and the tests were continued, with the sample finally failing at the extrapolated B16 level. During the testing, the surface temperature reached 600° C. before failure.

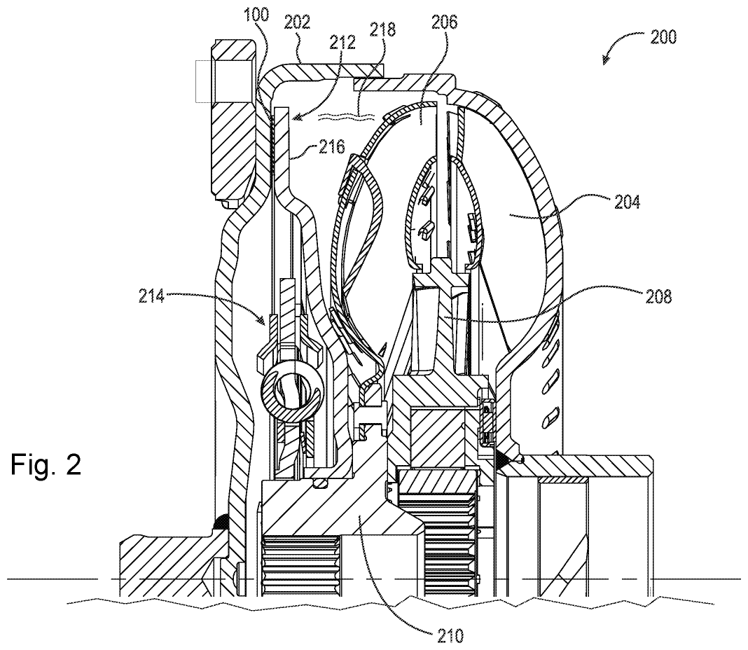

With reference to FIG. 2, a partial cross-sectional view of an example torque converter 200 is shown including friction material 100 shown in FIG. 1. Torque converter 200 may include cover 202, impeller 204 connected to the cover, turbine 206 in fluid communication with the impeller, stator 208, output hub 210 arranged to non-rotatably connect to an input shaft (not shown) for a transmission, torque converter clutch 212, and vibration damper 214. Clutch 212 may include friction material 100 and piston 216. As will be understood by a person of ordinary skill in the art, piston 216 may be displaceable to engage friction material 100 with piston 216 and cover 202 to transmit torque from cover 202 to output hub 210 through friction material 100 and piston 216. Fluid 218 is used to operate clutch 212.

Although a particular example configuration of torque converter 200 is shown in FIG. 2, it should be understood that the use of friction material 100 in a torque converter is not limited to a torque converter as configured in FIG. 2. That is, material 100 is usable in any clutch device, using friction material, for any torque converter configuration known in the art.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A wet friction material, comprising:
a plurality of fibers; and
a filler material including mica silicate and an additional silica-containing material, wherein:
the mica silicate comprises from 5 to 20 percent by weight of a total composition of the fibers and the filler material;
the mica silicate is in the form of particles having an aspect ratio of 50 to 70;
the additional silica-containing material is diatomaceous earth; and
the wet friction material is devoid of metal fibers.

2. The wet friction material of claim 1, wherein the mica silicate comprises from 7.5 to 17.5 percent by weight of the total composition of the fibers and the filler material.

3. (canceled)

4. (canceled)

5. The wet friction material of claim 1, wherein the mica silicate is in the form of particles having a particle size of 25 to 100 μm.

6. The wet friction material of claim 1, wherein the mica silicate is in the form of particles having a particle size of 40 to 80 μm.

7. (canceled)

8. The wet friction material of claim 1, wherein the wet friction material has a temperature resistance of at least 500° C.

9. The wet friction material of claim 1, wherein the wet friction material is devoid of carbon fibers, ceramic fibers, silica fibers and mineral fibers.

10. A wet friction material, comprising:
a plurality of fibers; and
a filler material including mica silicate with a Mohs hardness of 3, wherein the mica silicate comprises from 5 to 20 percent by weight of a total composition of the fibers and the filler material.

11. A wet friction material, comprising:
a plurality of fibers selected from the group consisting of cellulose fibers, aramid fibers, and carbon fibers, and combinations thereof;
a binder selected from the group consisting of phenolic resin and latex, and combinations thereof; and
a filler material including mica silicate and an additional silica-containing material, wherein:
the mica silicate is in the form of particles having an aspect ratio of 50 to 70;
the mica silicate comprises from 5 to 20 percent by weight of a total composition of the fibers and the filler material; and
the additional silica-containing material is selected from the group consisting of diatomaceous earth, aluminum silicate and silicon dioxide, and combinations thereof.

12. The wet friction material of claim 11, wherein:
the fiber material comprises 55 percent by weight of a total composition of the fibers and the filler material;
the fiber material consists of cellulose fibers and aramid fibers;
the filler material comprises 45 percent by weight of the total composition of the fibers and the filler material;
the mica silicate comprises 10 percent by weight of a total composition of the fibers and the filler material; and
the additional silica-containing material consists of diatomaceous earth.

13. The wet friction material of claim 11, wherein the binder comprises 35 percent by weight of the wet friction material.
